(19) United States
(12) Patent Application Publication
(10) Pub. No.: US 2025/0212164 A1
(43) Pub. Date: Jun. 26, 2025

(54) TARGET NODE FOR POSITIONING SYSTEMS

(71) Applicant: HUAWEI TECHNOLOGIES CO., LTD., Shenzhen (CN)

(72) Inventors: Sha Hu, Lund (SE); Hao Wang, Beijing (CN)

(73) Assignee: HUAWEI TECHNOLOGIES CO., LTD., Shenzhen (CN)

(21) Appl. No.: 19/074,207

(22) Filed: Mar. 7, 2025

Related U.S. Application Data
(63) Continuation of application No. PCT/CN2022/117698, filed on Sep. 8, 2022.

(51) Int. Cl. H04W 64/00; H04L 5/00

(52) U.S. Cl. CPC H04W 64/00; H04L 5/0048

(57) ABSTRACT

Embodiments of the invention relate to a first target node (100) for a positioning system (400). The first target node (100) is configured to receive positioning reference signals (410) and a positioning message (420) from at least one second target node (300). The positioning message (420) of the second target node (300) indicates at least one estimated position of the second target node (300). Based on the received positioning reference signals (410) and the positioning message (420) of the second target node (300) the first target node (100) determines at least one estimated position (P1) of its own position. Thereby, improved positioning accuracy is provided. Furthermore, the invention also relates to a corresponding method and a computer program.

### CROSS-REFERENCE TO RELATED APPLICATIONS

This application is a continuation of International Application No. PCT/CN2022/117698, filed on Sep. 8, 2022, the disclosure of which is hereby incorporated by reference in its entirety.

### TECHNICAL FIELD

Embodiments of the invention relate to a target node for positioning systems. Furthermore, embodiments of the invention also relate to a corresponding method and a computer program.

### BACKGROUND

Cooperative positioning (CoP) has emerging interests in coming vehicle-to-everything (V2X) and Internet-of-things (IoT) applications in 3GPP 5G new-radio (5G-NR) and 6G communication systems, where accurate positions/locations of vehicles and terminals are essential. Conventionally, CoP can be implemented via radio-links (RLs) among a number of target nodes (TNs) and anchor nodes (ANs) including gNBs, satellites, transmit and receive points (TRPs), radio-resource units (RRUs), road-side units (RSUs), or any other devices whose positions/locations are known. The locations of TNs are assumed unknown or partially unknown, and with the assistance from ANs and communications among different AN and TN nodes, the positions/locations of TNs can be estimated. The communications between different TN or AN can be through conventional RLs, such as in 5G-NR, or sidelinks (SLs). The group of the TNs and ANs that are engaging in a CoP procedure is called a CoP group (CPoG), which typically comprises a number of ANs and TNs. Due to the cooperation inside a CoPG, the positioning accuracies can be improved for all TNs via CoP compared to a conventional approach without any cooperation.

In general, CoP can be considered when conventional RL based positioning methods cannot work, for instance when a Global Navigation Satellite System (GNSS) is not available, or when connections from TNs to ANs are of bad quality or blocked out. However, CoP can also be applied even when conventional positioning techniques can work to achieve higher positioning accuracies.

With CoP, RLs and/or SLs between ANs and TNs are used to transmit positioning reference signals (PRSs) and exchange necessary information. With the transmission and reception of PRS signals different positioning techniques can be applied with observations and measurements from the PRS based on e.g., time of arrival (ToA), observed time difference of arrival (OTDoA), round trip time (RTT), reference signal received power (RSRP), angle-of-departure and arrival (AoD and AoA), etc.

### SUMMARY

An objective of embodiments of the invention is to provide a solution which mitigates or solves the drawbacks and problems of conventional solutions.

Another objective of embodiments of the invention is to provide a solution providing improved positioning accuracy compared to conventional solutions.

The above and further objectives are solved by the subject matter of the independent claims. Further embodiments of the invention can be found in the dependent claims.

According to a first aspect of the invention, the above mentioned and other objectives are achieved with a first target node for a positioning system, the first target node being configured to:
receive positioning reference signals from at least one second target node;
receive a positioning message of the second target node, the positioning message of the second target node indicating at least one estimated position of the second target node; and
determine at least one estimated position of the first target node based on the received positioning reference signals and the positioning message of the second target node.

A position herein may also be denoted as a spatial position, a location or a spatial location. It is furthermore understood that the first target node may receive a plurality of positioning reference signals from a plurality of second target node.

An advantage of the first target node according to the first aspect is that by exchanging positioning messages in the position system, the positioning accuracy can be improved compared to conventional solutions. Furthermore, the positioning algorithm of the first target node may be locally implemented and thus suitable for DCoP.

In an implementation form of a first target node according to the first aspect, the positioning message of the second target node further indicates a probability function of the estimated position of the second target node.

In an implementation form of a first target node according to the first aspect, the positioning message of the second target node indicates a plurality of estimated positions of the second target node and their respective probabilities.

An advantage of this implementation form is that that positioning format may be adapted to and depended on how many anchor nodes and other target nodes the first target node is connected to.

In an implementation form of a first target node according to the first aspect, the first target node being configured to:
transmit positioning reference signals; and
transmit a positioning message of the first target node, the positioning message of the first target node indicating at least one estimated position of the first target node.

The estimated position may the position/location of the first target node in a three-dimensional (3D) space or in a two-dimensional (2D) space, the latter e.g., the first node is located on the ground or a flat surface.

In an implementation form of a first target node according to the first aspect, the positioning message of the first target node further indicates a probability function of the estimated position of the first target node.

In an implementation form of a first target node according to the first aspect, the positioning message of the first target node indicates a plurality of estimated positions of the first target node and their respective probabilities.

In an implementation form of a first target node according to the first aspect, the probability function is a discrete probability function.

An advantage with this implementation form is that the control signaling overhead can be reduced in the positioning system.

In an implementation form of a first target node according to the first aspect, the first target node being configured to
transmit the positioning reference signals and the positioning message of the first target node sequentially.

An advantage with this implementation form is that the transmission of positioning reference signals and the positioning message can be independent, which is a more flexible transmission scheme, and can reduce the number of transmissions of the positioning reference signal. For instance, the first target node (and other target nodes) may only stop transmitting positioning reference signals when there are enough observations of positioning reference signals in the positioning system. However, the first target node (and other target nodes) may continue updating the positioning message as long as it receives updated positioning messages and/or new positioning reference signals from other target nodes and can use them to update its own positioning message.

In an implementation form of a first target node according to the first aspect, the first target node being configured to
transmit the positioning reference signals and the positioning message of the first target node concurrently.

An advantage with this implementation form is that the scheduling of transmission and reception of positioning reference signals and positioning messages can be made simpler since the transmission of positioning reference signals and positioning messages are bundled together, and it is also easier to avoid potential transmission collisions among different target nodes.

In an implementation form of a first target node according to the first aspect, the first target node being configured to
transmit the positioning reference signals and the positioning message of the first target node in a broadcast mode.

In an implementation form of a first target node according to the first aspect, the first target node being configured to
transmit positioning reference signals; and
transmit an updated positioning message of the first target node, the updated positioning message of the first target node indicating at least one updated estimated position of the first target node.

In an implementation form of a first target node according to the first aspect, the first target node being configured to:
transmit the updated positioning message of the first target node when the updated estimated position of the first target node is different to the estimated position of the first target node.

An advantage with this implementation form is that an updating mechanism is provided for an iterative positioning algorithm.

Another advantage with this implementation form is that it is possible to only update the estimated position when it receives a new PRS signal, or an updated positioning message from second target nodes. It thus keeps the message exchange to a minimum in the iterative positioning algorithm. Yet another advantage is that it may stop updating its positioning message when its estimate of position converges to a satisfying accuracy.

In an implementation form of a first target node according to the first aspect, the first target node and the second target node together form a MESH network.

According to a second aspect of the invention, the above mentioned and other objectives are achieved with a method for a first target node, the method comprises:
receiving positioning reference signals from at least one second target node;
receiving a positioning message of the second target node, the positioning message of the second target node indicating at least one estimated position of the second target node; and
determining at least one estimated position of the first target node based on the received positioning reference signals and the positioning message of the second target node.

The method according to the second aspect can be extended into implementation forms corresponding to the implementation forms of the first target node according to the first aspect. Hence, an implementation form of the method comprises the feature(s) of the corresponding implementation form of the first target node.

The advantages of the methods according to the second aspect are the same as those for the corresponding implementation forms of the first target node according to the first aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first target node according to an embodiment of the invention;

FIG. 2 shows a flow chart of a method for a first target node according to an embodiment of the invention;

FIG. 3 illustrates a first target node according to further embodiments of the invention;

FIG. 4 illustrates a positioning system according to an embodiment of the invention;

FIG. 5 illustrates a first transmission scheme according to embodiments of the invention;

FIG. 6 illustrates a second transmission scheme according to embodiments of the invention; and

FIG. 7 illustrates positioning accuracy.

### DETAILED DESCRIPTION

Conventionally, CoP can be categorized in two main directions, namely, centralized CoP (CCoP) and distributed CoP (DCOP). The main difference is that with CCoP there can be a location server (LCS), which can receive all measurements and estimates from all TNs and ANs in a CPoG. Afterwards, the LCS can implement a centralized and joint positioning algorithm to locate all TNs, and then send these location estimates back to TNs. On contrast, with DCoP, there is no such a centralized LCS, and each TN determines its own position/location via message exchange with other TNs and ANs. It may be noted that since the positions/locations of ANs are already known, each AN only needs to notify those TNs about its position/location in the beginning of a CoP procedure. Afterwards, each AN may only needs to transmit PRS to other TNs which may conduct measurements of distances and/or angles.

In general, the CCoP can yield a better positioning accuracy of TNs compared to the DCoP, due to joint-processing gains. However, CCoP in general also yields a higher complexity and processing latency. Moreover, CCoP is only feasible for a CPoG of a small number of nodes. As the number of TN and AN increase, the scalability of CCoP is not as good as for DCoP. On the other hand, DCoP runs the positioning algorithm at each TN locally, and the computational complexity is much lower compared to CCoP. Further, DCOP is also easier to involve more TNs or ANs and the connection topology among the TNs and ANs is flexible. For instance, each TN may only connect to a few adjacent nodes via SLs for PRS transmissions and message exchange locally, while the entire CoPG can still be large and all nodes exchange information with each other through intermediate nodes in an implicitly manner. In addition, some nodes (either TN or AN) can drop out from the CoPG anytime without affecting the entire DCoP procedure to continue.

Although DCoP has an emerging interest, it commonly assumes a perfect message exchanging among target nodes, and the message can vary depending on the detailed algorithms applied. In practical scenarios and especially for product-engineering, only limited amount of information can be exchanged, due to limits in transmission-latency, payload-size, and precisions. How to design the message in association to an effective DCoP implementation is crucial for successfully applying DCoP for a positioning system.

Thus, embodiments of the invention disclose a novel positioning scheme and associated message exchange and message format. The positioning scheme may in embodiments of the invention be a DCOP scheme.

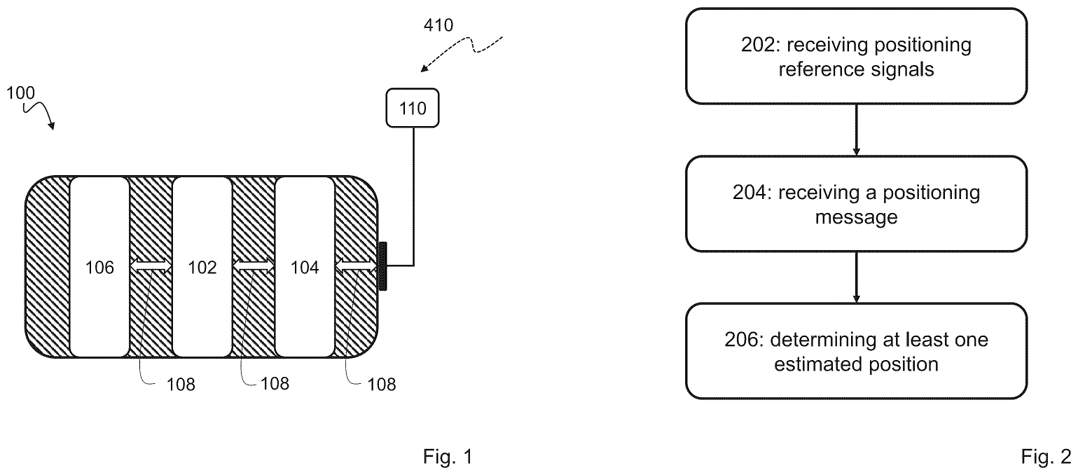

FIG. 1 shows a first target node 100 according to an embodiment of the invention. In the embodiment shown in FIG. 1, the first target node 100 comprises a processor 102, a transceiver 104 and a memory 106. The processor 102 is coupled to the transceiver 104 and the memory 106 by communication means 108 known in the art. The first target node 100 further comprises an antenna or antenna array 110 coupled to the transceiver 104, which means that the first target node 100 is configured for communications in a communication system and thus also in a positioning system.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset. That the first target node 100 is configured to perform certain actions can in this disclosure be understood to mean that the first target node 100 comprises suitable means, such as e.g., the processor 102 and the transceiver 104, configured to perform the actions.

According to embodiments of the invention, the first target node 100 is configured to receive positioning reference signals 410 from at least one second target node 300. The first target node 100 is further configured to receive a positioning message 420 of the second target node 300, the positioning message 420 of the second target node 300 indicating at least one estimated position of the second target node 300. The first target node 100 is further configured to determine at least one estimated position P1 of the first target node 100 based on the received positioning reference signals 410 and the positioning message 420 of the second target node 300.

Furthermore, in embodiments of the invention, the first target node 100 comprises: a transceiver configured to: receive positioning reference signals 410 from at least one second target node 300; and receive a positioning message 420 of the second target node 300, the positioning message 420 of the second target node 300 indicating at least one estimated position of the second target node 300. The first target node 100 further comprises a processor configured to: determine at least one estimated position P1 of the first target node 100 based on the received positioning reference signals 410 and the positioning message 420 of the second target node 300.

Moreover, in yet further embodiments of the invention, the first target node 100 comprises a processor and a memory having computer readable instructions stored thereon which, when executed by the processor, cause the processor to: receive positioning reference signals 410 from at least one second target node 300; receive a positioning message 420 of the second target node 300, the positioning message 420 of the second target node 300 indicating at least one estimated position of the second target node 300; and determine at least one estimated position P1 of the first target node 100 based on the received positioning reference signals 410 and the positioning message 420 of the second target node 300.

FIG. 2 shows a flow chart of a corresponding method 200 which may be executed in a first target node 100, such as the one shown in FIG. 1. The method 200 comprises receiving 202 positioning reference signals 410 from at least one second target node 300. The method 200 further comprises receiving 204 a positioning message 420 of the second target node 300, the positioning message 420 of the second target node 300 indicating at least one estimated position of the second target node 300. The method 200 further comprises determining 206 at least one estimated position P1 of the first target node 100 based on the received positioning reference signals 410 and the positioning message 420 of the second target node 300.

In a positioning system 400 according to embodiments of the invention, each target node may act both as a transmitter and a receiver. Thus, in the downlink (DL) transmission each target node broadcasts both the positioning signal intended for positioning, such as positioning reference signal (PRS) to other target nodes of the positioning system 400, and also the positioning message that contains the information of its own position/location in the form of an estimated position. Meanwhile, in the UL each target node receives both the PRS, and the positioning messages from other target nodes of the positioning system 400. After having received UL positioning messages, each target node estimates its own position/location, and updates the positioning message, and broadcasts the updated positioning message in the DL to the other target nodes of the positioning system 400. The same procedure applies to all target nodes in the same CoPG.

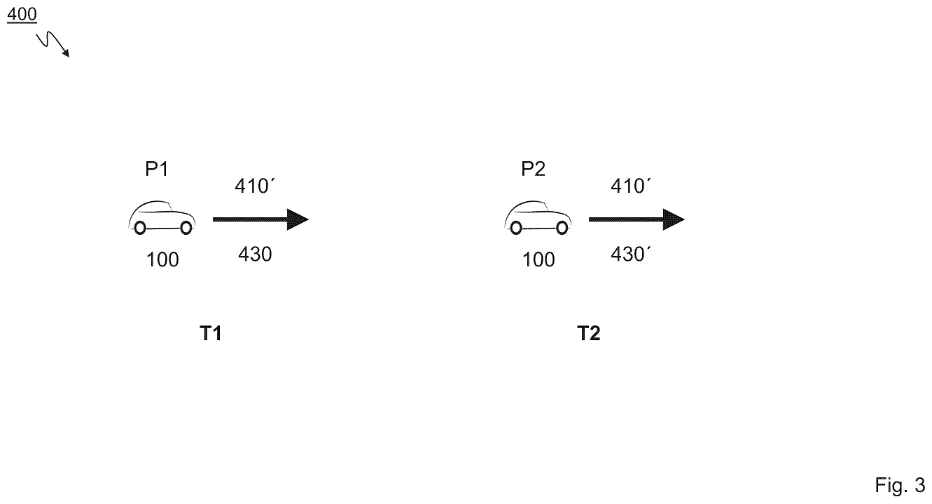

Hence, with reference to FIG. 3 in embodiments of the invention, the first target node 100 is further configured to transmit positioning reference signals 410′, and further to transmit a positioning message 430 of the first target node 100 in a first time instance T1. The positioning message 430 of the first target node 100 indicates at least one estimated position P1 of the first target node 100. Moreover, the first target node 100 will also have the capability to transmit positioning reference signals 410′ and also to transmit an updated positioning message 430′ of the first target node 100 in a second time instance T2 following the first time instance T1. The updated positioning message 430′ of the first target node 100 hence indicates at least one updated estimated position P2 of the first target node 100. For making it possible for all other target nodes in the positing system 400 to be able to receive the positioning reference signals and the positioning messages, the first target node 100 transmits in a broadcast mode.

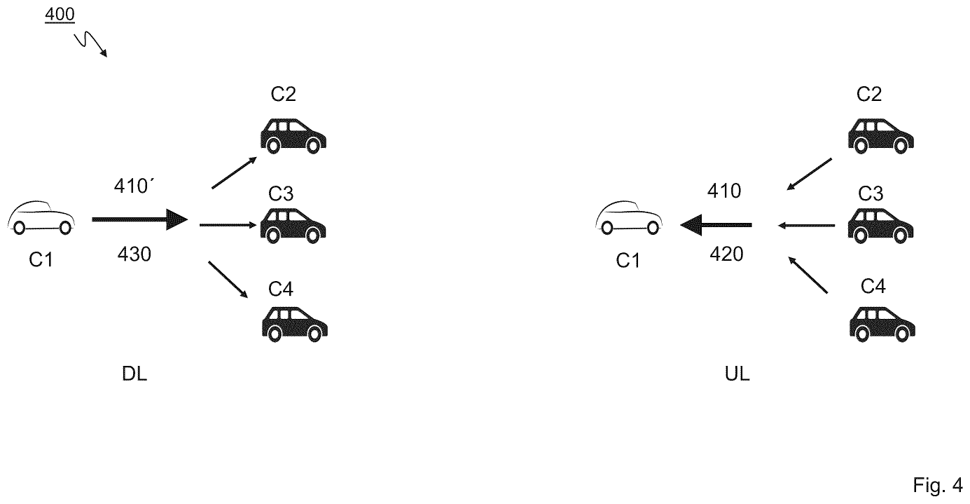

FIG. 4 illustrates a positioning system 400 according to embodiments of the invention. The positioning system 400 in the disclosed example comprises a first target node 100 and a plurality of second target nodes 300 configured to communicate and operate in the positioning system 400. A general DCoP scheme is illustrated among four cars of FIG. 4 in the CoPG where the first target node 100 is car 1 (C1) and cars 2-4 (C2, C3, C4) are second target nodes 300.

The DCOP scheme may be implemented as the following: the first target node broadcasts in the DL a PRS 410′ and its positioning message 430 to the second target nodes in the positioning system 400. The receiving second target nodes C2, C3, C4 can therefore conduct measurements based on the received PRS 410′. The measurements may be determined using any suitable methods such as ToA, TDoA, etc. Further, each second target 300 node also receives the positioning message 430 of the first target node 100. The second target nodes thus estimate their positions based on the received PRS 410′ and its positioning message 430 of the first target node 100. In the UL, the first target node 100 receives PRSs 410 and positioning messages 420 from the second target nodes. Based on the received PRSs 410 and positioning messages 420 from the second target nodes, the first target node 100 determines an updated estimated position which may be broadcasted to the second target nodes in an updated positioning message.

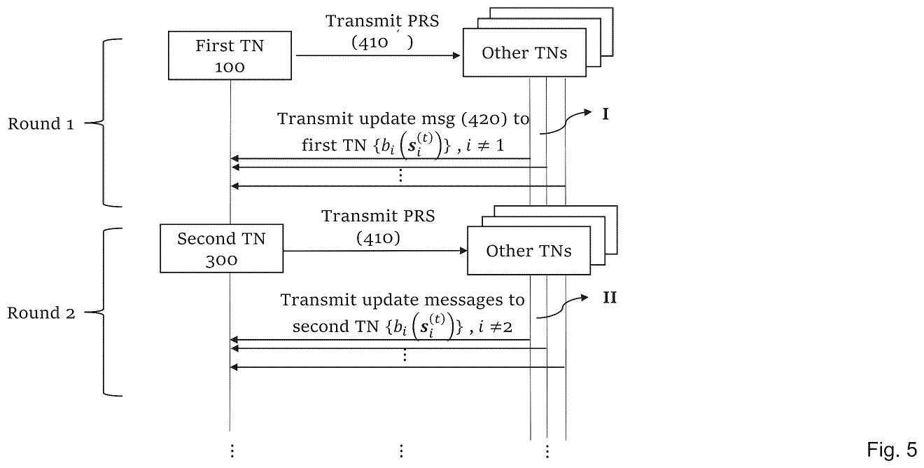

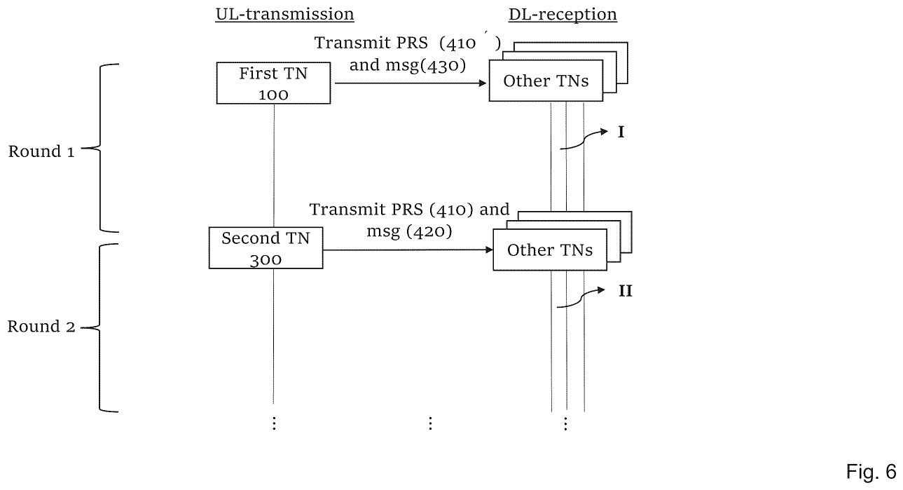

Furthermore, embodiments of the invention also relate to a first and second transmission scheme which are illustrated in FIGS. 5 and 6.

The first transmission scheme is illustrated in FIG. 5. In a first round, a first target node 100 broadcasts PRS on SL to the other target nodes (i.e., the second targets nodes) in DL. Thus, the other target nodes that have SL connections to the first target node 100 in their UL will receive sidelink PRS (SL-PRS) and conducting measurements of the SL-PRS that will be used for positioning. At step I, each of these other target nodes will run algorithms to estimate its own position and update its own positioning message bᵢ(sᵢ^{(t)}), which is the probability of its own location sᵢ^{(t)}. The index i is the target node index, and the index t denotes the iteration index of the DCOP algorithm. The set of values bᵢ(sᵢ^{(t)}) are broadcasted from the ith target nodes to other target nodes including the first target node 100. In a second round following the first round, a second target node 300 transmits SL-PRS to other nodes in DL, and all the remaining target nodes including the first target node 100 will conduct the same procedure in step II as described in the first round. This procedure of first and second rounds continues until the DCoP algorithm completes, i.e., the estimates of positions converge for all target nodes. This means that in embodiments of the invention, the first target node 100 is configured to transmit the positioning reference signals 410′ and the positioning message 430 of the first target node 100 sequentially. Hence, the transmission of the PRS and the positioning message is not bundled in the first transmission scheme and are transmitted independently in different time slots, frames, windows, etc.

It may be noted that with the first transmission scheme, both UL and DL transmissions among the target nodes of the positioning system 400 can be made in parallel if they are allocated with non-overlapping transmission resources in terms of frequency-bands and time-intervals. Otherwise, these transmissions can take orders upon an agreed manner among target nodes if the transmissions are performed on overlapping resources to avoid collision and contamination.

The second transmission scheme is illustrated in FIG. 6. In a first round, a first target node 100 transmits both PRS 410′ and its positioning message 430 to other target nodes in the DL, and then all the remaining target nodes will in their UL receive the PRS and measure the distances between them to the first target node 100. Afterwards, each of the other target nodes will run algorithms to estimate its own position and update their position message. In a second round following the first round, a second target node 300 transmits SL-PRS and its messages to other nodes in DL, and all the remaining target nodes will conduct the same process as before. So, on and forth until the DCOP algorithm completes. This means that in embodiments of the invention, the first target node 100 is configured to transmit the positioning reference signals 410′ and the positioning message 430 of the first target node 100 concurrently. Hence, the transmission of the PRS and the positioning message is bundled in the second transmissions scheme.

It may be noted that with the second transmission scheme, the total transmission occurrences in the positioning system 400 are less than in the first transmission scheme. However, the updating of the positioning messages is less frequent in the second transmission scheme compared to the first transmission scheme and is thus not as flexible as the first transmission scheme since the transmission of PRSs and positioning messages are bundled.

### Message Format

Exchanged positioning messages in positioning systems are curtail for the success of positioning schemes and this is especially the case for DCoP. In additional to the previous disclosed positioning and transmission schemes, the message format of the positioning messages 420, 430 will be described more in detail in the following disclosure.

A belief-propagation (BP) or also known as message passing (MP) based DCoP positioning scheme herein disclosed means that each target node, i.e., a first target node 100 and a second target node 300, of the positioning system 400 is configured to:
Compute the belief μ_{j→i}(sᵢ^{(t)}) in the form of a function, such as a probability density function (pdf), based on received and measured PRS

$${z}_{j \to i}^{( t )} : {μ}_{j \to i} ( {s}_{i}^{( t )} ) ∝ {\int }_{{s}_{j}^{( t )}} p ( {z}_{j \to i}^{( t )} \vert {s}_{i}^{( t )} , {s}_{j}^{( t )} ) {b}_{j} ( {s}_{j}^{( t )} ) {ds}_{j}^{( t )}$$

Broadcast the pdf bᵢ(sᵢ^{(t)}) in positioning messages to other target nodes in the positioning system 400

$${b}_{i} ( {s}_{i}^{( t )} ) ∝ {\prod }_{j \neq i} {μ}_{j \to i} ( {s}_{i}^{( t )} )$$

where
z_{j→i}^{(t)} is the observation of SL-PRS seen at the ith target node and transmitted from the jth target node or AN.
sⱼ^{(t)} is the estimated position of the jth target node at tth iteration.
p(z_{j→i}^{(t)}, sⱼ^{(t)}) is the conditional probability of the observation z_{j→i}^{(t)} given the positions sᵢ^{(t)} and sⱼ^{(t)}.
μ_{j→i} (sᵢ^{(t)}) are the beliefs computed with the SL-PRS transmission from the jth target node.
bⱼ(sⱼ^{(t)}) is the pdf of a possible position sⱼ^{(t)}.

As seen from the above, the information content transmitted in the positioning message is according to embodiments of the invention pairs comprising an estimated position and the probability for the estimated position for a target node, i.e., (sᵢ^{(t)},bᵢ(sᵢ^{(t)})). This information content will be utilized by another kth target node to compute the belief μ_{i→k}(sₖ^{(t)}) and pdf bₖ(sₖ^{(t)}) with SL-PRS transmitted from the ith target node and received by the kth target node as explained previously.

Furthermore, we examine the possible forms of the pdf bᵢ(sᵢ^{(t)}) under different cases, i.e.:
1. If the ith target node is only connected to a single AN without prior information about its position at the tth iteration step, the pdf bᵢ(sᵢ^{(t)}) is circularly distributed on a circle or a sphere-surface centered at the AN, for a 2D or a 3D deployment and positioning, respectively. In both cases, a number of discrete samples of the positions on the circle or sphere surface can be sampled and transmitted. This typically happens when the algorithm starts, i.e., at time instance t=0.
2. If the ith target node is connected to 2 ANs without prior information about its position at the tth iteration, the pdf bᵢ(sᵢ^{(t)}) can have a bimodal distribution and only 2 estimated positions are possible for a 2D deployment, while it can have circularly distributed on a circle for a 3D deployment. In the latter case, a number of discrete samples of the positions on the circle can be sampled and transmitted.
3. If the ith target node is connected to 3 ANs without prior information about its location at the tth iteration, the pdf bᵢ(sᵢ^{(t)}) can have a unimodal distribution and only 1 estimated position is possible for a 2D deployment, while for a 3D deployment, the pdf bᵢ(sᵢ^{(t)}) can have a bimodal distribution and only 2 estimated positions are possible.
4. If the ith target node is connected to 4 or more ANs, or less than 4 ANs but with prior information about its location at the tth iteration, the pdf bᵢ(sᵢ^{(t)}) can have a unimodal distribution and only 1 estimated position is possible for both 2D and 3D deployments.

Therefore, from the above analysis, in embodiments of the invention, the positioning message 420 of the second target node 300 further indicates a probability function of the estimated position of the second target node 300 and that the positioning message 420 of the second target node 300 may indicate a plurality of estimated positions of the second target node 300 and their respective probabilities. Correspondingly, the positioning message 430 of the first target node 100 further indicates a probability function of the estimated position P1 of the first target node 100 and may also indicate a plurality of estimated positions of the first target node 100 and their respective probabilities.

In all the above cases, the pdf can be transmitted in a discretized form with only a few samples. Thus, the mentioned probability function is a discrete probability function in embodiments of the invention. Therefore, it is proposed a general message format for the positioning message that is according to Table 1. A first column represents the estimated positions for the mth target node and a second column represent the probability for these estimated positions.

TABLE 1

| Estimated position | Probability |
|---|---|
| s_{m, 1} | p(s_{m, 1}) |
| s_{m, 2} | p(s_{m, 2}) |
| . | . |
| . | . |
| . | . |
| s_{m, M} | p(s_{m, M}) |

It may be noted that since the sum of all probabilities is 1, one probability value from the list may not be transmitted to save the transmission payload. For example, one probability p(s_{m,n}) for the estimated position s_{m,n} does not have to be transmitted, since it can be derived from the other transmitted probabilities through:

$$p ( {s}_{m , n} ) = 1 - {\sum }_{k = 1 , k \neq n}^{M} p ( {s}_{m , k} ) .$$

When the mth target node is connected to 2 ANs in a 2D deployment, the estimated pdf bᵢ(sᵢ^{(t)}) has a bimodal distribution, and the transmitted positioning message can have the format according to Table 2. Since p(s_{m,2})=1−p(s_{m,1}), only the value p(s_{m,1}) needs to be transmitted. However, both estimated locations s_{m,1} and s_{m,2} need to be transmitted.

TABLE 2

| Estimated position | Probability |
|---|---|
| s_{m, 1} | p(s_{m, 1}) |
| s_{m, 2} | 1 − p(s_{m, 2}) |

While if the mth target node is connected to 3 or more ANs for a 2D deployment, the estimated pdf bᵢ(sᵢ^{(t)}) can have a unimodal distribution, and the positioning message can have the format according to Table 3. In this case, since there is a single estimated position s_{m,1} it holds that p(s_{m,1})=1, and no probability value need to be transmitted.

TABLE 3

| Estimated position | Probability |
|---|---|
| s_{m, 1} | 1 |

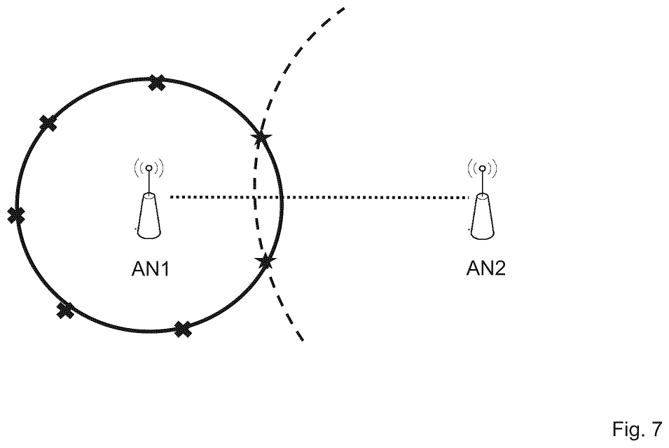

FIG. 7 illustrates an example of the estimated positions for the case the first target node 100 is connected to a single AN or to two ANs (AN1 and AN2) for a 2D deployment. The crosses in FIG. 7 illustrates possible positions sampled from a continues pdf bᵢ(sᵢ^{(t)}) for the case when the first target node 100 is connected to a single AN. In this case, a number of sampled positions, which equals to 7 in FIG. 7, with their respective probabilities are transmitted in a positioning message following the general format given in Table 1. While the stars in FIG. 7 illustrate possible positions for the case when the first target node 100 is connected to two different ANs. In this case, there are only two possible positions. These estimated positions with their probabilities are transmitted as positioning messages following the general format in Table 2.

Further aspects of the invention may be that each target node, i.e., first target node 100 and second target node(s) 300, only updates its own positioning message when the estimated position has been updated, i.e., the content of the positioning message is different from what transmitted in a previous occasion to save the transmission resources. In other words, the first target node 100 thus transmits the updated positioning message 430′ of the first target node 100 when the updated estimated position P2 of the first target node 100 is different to the estimated position P1 of the first target node 100.

Moreover, each target node in the present disclosed positioning system 400 may drop out from a DCOP when its own position estimation is satisfactory. That a position estimation is satisfactory may be determined using as accuracy threshold value which may be dependent on the application. This may mean that such a target node may stop transmitting SL-PRS and also stop updating the positioning message. This will in general not impact the operations of other target nodes of a DCoP positioning system. The first target node 100 may further broadcast an indication message to notify other target nodes that it will drop out, such that the other target nodes will stop listening for positioning messages and thus saving power. The other target nodes may also reuse the transmission resources allocated to the target node that has or will drop out. The whole DCoP may end when all target nodes in the positioning system 400 have dropped out, which implies that no further updates in positioning messages are exchanged between the target nodes forming the DCoP positioning system. This may save the overall processing latency of the DCOP procedure.

A first target node 100 herein may be denoted as a user device, a user equipment (UE), a mobile station, a V2X, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first target node 100 comprises the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first target node 100 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A first target node (100) for a positioning system (400), the first target node (100) being configured to:
receive positioning reference signals (410) from at least one second target node (300);
receive a positioning message (420) of the second target node (300), the positioning message (420) of the second target node (300) indicating at least one estimated position of the second target node (300); and
determine at least one estimated position (P1) of the first target node (100) based on the received positioning reference signals (410) and the positioning message (420) of the second target node (300).

2. The first target node (100) according to claim 1, wherein the positioning message (420) of the second target node (300) further indicates a probability function of the estimated position of the second target node (300).

3. The first target node (100) according to claim 2, wherein the positioning message (420) of the second target node (300) indicates a plurality of estimated positions of the second target node (300) and their respective probabilities.

4. The first target node (100) according to claim 1, configured to transmit positioning reference signals (410′); and
transmit a positioning message (430) of the first target node (100), the positioning message (430) of the first target node (100) indicating at least one estimated position (P1) of the first target node (100).

5. The first target node (100) according to claim 4, wherein the positioning message (430) of the first target node (100) further indicates a probability function of the estimated position (P1) of the first target node (100).

6. The first target node (100) according to claim 5, wherein the positioning message (430) of the first target node (100) indicates a plurality of estimated positions of the first target node (100) and their respective probabilities.

7. The first target node (100) according to claim 1, wherein the probability function is a discrete probability function.

8. The first target node (100) according to claim 4, configured to:
transmit the positioning reference signals (410′) and the positioning message (430) of the first target node (100) sequentially.

9. The first target node (100) according to claim 4, configured to:
transmit the positioning reference signals (410′) and the positioning message (430) of the first target node (100) concurrently.

10. The first target node (100) according to claim 4, configured to:
transmit the positioning reference signals (410′) and the positioning message (430) of the first target node (100) in a broadcast mode.

11. The first target node (100) according to claim 4, configured to:
transmit positioning reference signals (410′); and
transmit an updated positioning message (430′) of the first target node (100), the updated positioning message (430′) of the first target node (100) indicating at least one updated estimated position (P2) of the first target node (100).

12. The first target node (100) according to claim 11, configured to:
transmit the updated positioning message (430′) of the first target node (100) when the updated estimated position (P2) of the first target node (100) is different to the estimated position (P1) of the first target node (100).

13. The first target node (100) according to claim 1, wherein the first target node (100) and the second target node (300) together form a MESH network.

14. A method (200) for a first target node (100), the method (200) comprising:
receiving (202) positioning reference signals (410) from at least one second target node (300);
receiving (204) a positioning message (420) of the second target node (300), the positioning message (420) of the second target node (300) indicating at least one estimated position of the second target node (300); and
determining (206) at least one estimated position (P1) of the first target node (100) based on the received positioning reference signals (410) and the positioning message (420) of the second target node (300).

15. The method (200) according to claim 14, wherein the positioning message (420) of the second target node (300) further indicates a probability function of the estimated position of the second target node (300).

16. The method (200) according to claim 15, wherein the positioning message (420) of the second target node (300) indicates a plurality of estimated positions of the second target node (300) and their respective probabilities.

17. The method (200) according to claim 14, further comprising:
transmitting positioning reference signals (410′); and
transmitting a positioning message (430) of the first target node (100), the positioning message (430) of the first target node (100) indicating at least one estimated position (P1) of the first target node (100).

18. The method (200) according to claim 17, wherein the positioning message (430) of the first target node (100) further indicates a probability function of the estimated position (P1) of the first target node (100).

19. The method (200) according to claim 18, wherein the positioning message (430) of the first target node (100) indicates a plurality of estimated positions of the first target node (100) and their respective probabilities.

20. A non-transitory computer readable medium comprises a computer program with a program code for performing:
receiving positioning reference signals from at least one second target node;
receiving a positioning message of the second target node, the positioning message of the second target node indicating at least one estimated position of the second target node; and
determining at least one estimated position (P1) of the first target node based on the received positioning reference signals and the positioning message of the second target node.
